(19) United States
(12) Patent Application Publication
(10) Pub. No.: US 2023/0065938 A1
(43) Pub. Date: Mar. 2, 2023

(54) PROCESS FOR CHEMICALLY MODIFYING A POLYMERIC PART IN ORDER TO IMPART FLAME-RETARDANT PROPERTIES THERETO OR TO IMPROVE SAID PROPERTIES INVOLVING A COVALENT REACTION WITH AT LEAST ONE COMPOUND BEARING AN ISOCYANATE GROUP

(71) Applicant: COMMISSARIAT Á L'ÉNERGIE ATOMIQUE ET AUX ÉNERGIES ALTERNATIVES, Paris (FR)

(72) Inventors: Jérôme Delmas, Grenoble (FR); Olivier Blanchot, Grenoble (FR); Pierre Piluso, Grenoble (FR); Olivier Poncelet, Grenoble (FR); Isabelle Rougeaux, Grenoble (FR)

(21) Appl. No.: 17/904,749

(22) PCT Filed: Feb. 17, 2021
(86) PCT No.: PCT/FR2021/050275

§ 371 Date: Aug. 22, 2022

(30) Foreign Application Priority Data
Feb. 26, 2020 (FR) FR2001882

(51) Int. Cl. C08J 7/16; C08K 5/00; C08K 5/521

(52) U.S. Cl. CPC C08J 7/16; C08K 5/0066; C08K 5/521; C08J 2377/02

(57) ABSTRACT

A process for chemically modifying a polymeric part in order to impart flame-retardant properties thereto or to improve the properties, the process comprising the following steps: a step of reacting a polymeric part comprising at least one polymer comprising, as reactive groups, amine groups and/or hydroxyl groups, with a functional compound, referred to as first compound, comprising at least one isocyanate group and at least one vinyl type polymerisable group, the isocyanate groups reacting, covalently with all or some of the amine groups and/or hydroxyl groups of the polymer(s), resulting in a polymeric part bonded, covalently, to residues of the functional compound; using the vinyl type polymerisable groups of the residues of the functional compound, a step of polymerising a second compound comprising at least one vinyl type polymerisable group and at least one group comprising at least one phosphorus atom, the reaction step and said polymerisation step being carried out in the presence of at least one supercritical fluid.

### TECHNICAL FIELD

The present invention relates to a process for chemically modifying a polymeric part in order to impart flame-retardant properties thereto or to improve said properties, said process being performed in a medium enabling a chemical modification both on the surface and in the core of the polymeric part, i.e. in other words in the entire volume of the part.

Conventionally, the properties of a polymeric part can be modified or improved in different ways, such as for example:
adding one or more organic or inorganic fillers to form a composite material, with however the possibility of the presence of fillers having a negative effect on the properties of the polymer that it is not sought to modify; or
impregnating the polymer with one or more chemical agents making it possible to impart or improve the targeted property with however the following drawback(s):
the impregnation merely results in a surface treatment and cannot reach the part in-depth, the targeted property thus only being localised on the surface of the part;
the impregnation does not allow strong binding of the chemical agent(s), the targeted property imparted by this or these agent(s) not having a satisfactory hold over time.

In the light of the above, the authors of the present invention proposed to develop a process for modifying a polymeric part in order to impart flame-retardant properties thereto or to improve said properties which does not have the limitations of the processes mentioned above.

### DISCLOSURE OF THE INVENTION

Thus, the invention relates to a process for chemically modifying a polymeric part in order to impart flame-retardant properties thereto or to improve said properties, said process comprising the following steps:
a step of reacting a polymeric part comprising at least one polymer comprising, as reactive groups, amine groups and/or hydroxyl groups, with a functional compound, also referred to as first compound, comprising at least one isocyanate group and at least one vinyl type polymerisable group, the isocyanate groups reacting, covalently with all or some of the amine groups and/or hydroxyl groups of the polymer(s), resulting in a polymeric part bonded, covalently, to residues of the functional compound;
using the vinyl type polymerisable groups of the residues of the functional compound, a step of polymerising a second compound comprising at least one vinyl type polymerisable group and at least one group comprising at least one phosphorus atom,

said reaction step and said polymerisation step being carried out in the presence of at least one supercritical fluid.

It is specified that the term polymeric part means, conventionally, a part made of a material comprising at least one polymer comprising, as reactive groups, amine groups and/or hydroxyl groups, said polymer(s) being formed into the part, for example, by a forming technique, such as the 3D printing technique or the extrusion/injection technique, the process according to the invention thus being capable of fitting into the production cycle of a part at the “post-process” stage (i.e. the stage of finishing the part after the forming thereof).

Thanks to the use of at least one supercritical fluid to carry out the reaction steps mentioned above, the following advantages were observed:
the possibility of carrying the functional compound and the second compound deep into the polymeric part and thus enabling a chemical modification thereof both on the surface and in-depth and therefore in the entire part;
a high solvating power, which makes it possible to impart substantially more rapid reaction kinetics to the reaction steps compared to similar reactions, which would be conducted in a non-supercritical medium;
the possibility of carrying out said modification without using volatile organic solvent, the removal whereof post-reaction would be costly in terms of energy and time and traces whereof would be potentially present in the treated parts;
the possibility of carrying out said modification by limiting the quantity of reagent(s) used, where applicable, of catalyst(s), and the residual quantity of reagent(s), where applicable, of catalyst(s) in the polymeric parts compared to conventional impregnation processes.

Moreover, the process according to the invention can have the following advantages:
an easy-to-industrialise process including a small number of steps, not requiring, as a general rule, large quantities of products (which is one advantage of the use of a supercritical fluid over submergence techniques in a liquid solvent) and enabling the simultaneous treatment of several parts;
no prior preparation of the surface of the parts to be treated;
the possibility of treating all the complex reliefs of the parts, where applicable.

The term supercritical fluid denotes a fluid brought to a pressure and a temperature beyond the critical point thereof, corresponding to the temperature and pressure pair (Tc and Pc respectively), for which the liquid phase and the gas phase have the same density and beyond which the fluid is located in the supercritical range thereof. Under supercritical conditions, the fluid has substantially greater dissolution power compared to the same fluid under non-supercritical conditions and hence facilitates the solubilisation of the functional compound and the second compound. It is understood that the supercritical fluid used is capable of solubilising the functional compound and the second compound used.

The supercritical fluid can be, advantageously, supercritical CO₂, particularly due to the low critical temperature thereof (31° C.), which makes it possible to carry out the reaction at a low temperature without any risk of degradation of the functional compound and the second compound. More specifically, supercritical CO₂ is obtained by heating carbon dioxide beyond the critical temperature thereof (31° C.) and by compressing it above the critical pressure thereof (73 bar). Moreover, supercritical CO₂ is non-flammable, non-toxic, relatively inexpensive and does not require post-process reprocessing, compared to processes involving the exclusive use of organic solvent, which also makes it an industrially relevant “green” solvent. Finally, supercritical CO₂ has a good solvating power (adaptable according to the pressure and temperature conditions used), a low viscosity and a high diffusivity. Finally, the gaseous nature thereof under ambient pressure and temperature conditions makes, after the steps and once the CO₂ has returned to a non-supercritical state, the steps of separating the part thus modified and the reaction medium (comprising, for example, unreacted compounds) and also the reuse of CO₂, easy to carry out. Moreover, supercritical CO₂ is capable of diffusing deep into the polymeric part and contributing to the plasticising thereof, which can facilitate the reaction steps. All these conditions mentioned above help make supercritical CO₂ an excellent choice of solvent for carrying out the steps of the process according to the invention.

As mentioned above, the process according to the invention comprises, firstly, a step of reacting a polymeric part comprising at least one polymer comprising, as reactive groups, amine groups and/or hydroxyl groups, with a functional compound, referred to as first compound, comprising at least one isocyanate group and at least one vinyl type polymerisable group, the isocyanate groups reacting, covalently with all or some of the amine groups and/or hydroxyl groups of the polymer(s), resulting in a polymeric part bonded, covalently, to residues of the functional compound (the residues being what remains of the functional compound after it has reacted via the isocyanate group(s) thereof with the amine groups and/or the hydroxyl groups of the polymer(s) of the polymeric part, it being understood that these residues further comprise at least one vinyl type polymerisable group).

The polymeric part intended to be treated according to the process of the invention is a part comprising (or consisting solely of) at least one polymer comprising, as reactive groups, amine groups and/or hydroxyl groups, the amine groups reacting, covalently, with the isocyanate groups of the functional compound to form a urea bond and the hydroxyl groups reacting, covalently, with the isocyanate groups of the functional compound to form a urethane bond.

In particular, the polymeric part intended to be treated according to the invention can be a part comprising (or consisting solely of) one or more polyamides and, even more specifically, the polymeric part can be a part made of polyamide-12, the reactive groups being, in this case, amine groups. More specifically, the part can be made of porous or partially porous polyamide-12 and, even more specifically, a polyamide-12 having a density less than or equal to 960 kg/m³, for example ranging from 650 kg/m³ to 960 kg/m³, preferably less than or equal to 900 kg/m³, for example ranging from 700 kg/m³ to 900 kg/m³.

The functional compound is, advantageously, a non-polymeric compound, i.e. it is not a polymer, i.e. a compound comprising a chain of repeat unit(s), which enables it to access the core of the polymeric part more easily and react covalently with the reactive groups located in the core of the polymeric part.

According to the functional compound selected, a person skilled in the art will choose the operating parameters to enable the covalent reaction with the reactive groups of the polymeric part, these operating parameters being capable of being determined with prior tests.

By way of example, when the polymer is a polyamide-12, the reaction step can be illustrated by the following simplified reaction diagram:

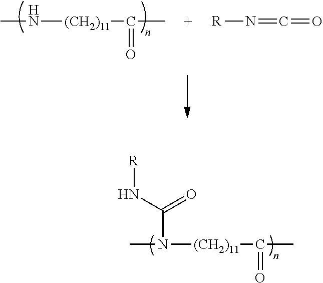

R—NH—CO— corresponding to a residue of the functional compound R—N═C=O bonded, covalently, to the polyamide via the nitrogen atom and n corresponding to the repeat number of the repeat unit between brackets.

More specifically, the functional compound can be a compound comprising an isocyanate group, at least one vinyl type polymerisable group and at least one group comprising at least one phosphorus atom, such as a phosphorus group or a phosphonate group.

By way of examples, the functional compound can be derived from bis[2-(methacryloyloxy)ethyl]phosphate, diethylallylphosphate, diethylallylphosphonate, dimethylvinylphosphonate or diethylvinylphosphonate.

In particular, the functional compound can be a compound derived from bis[2-(methacryloyloxy)ethyl]phosphate and can comply with the following formula:

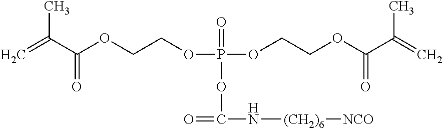

this compound being capable of being prepared with a nucleophilic addition reaction of bis[2-(methacryloyloxy)ethyl]phosphate with hexamethylenediisocyanate, this nucleophilic addition reaction being capable of being illustrated with the following reaction diagram:

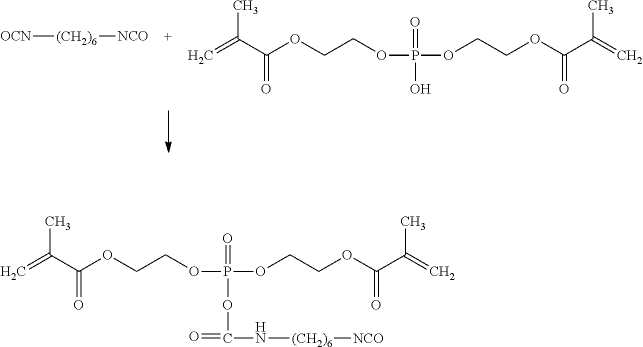

This nucleophilic additional reaction can be carried out in a medium not comprising supercritical fluid(s).

Furthermore, the reaction step of the process according to the invention can be carried out in the presence of at least one cosolvent, which can make it possible to improve the solubility of the functional compound and/or improve the plasticity of the polymeric part and thus facilitate the accession of the functional compound to the core of the polymeric part, and/or at least one catalyst.

More specifically, the reaction step can include the following operations:
an operation of placing, in a reactor, the polymeric part, the functional compound, optionally at least one cosolvent and optionally at least one catalyst;
an operation of introducing CO₂ into the reactor;
an operation of pressurising and heating the reactor to a temperature greater than the critical temperature of CO₂ and to a pressure greater than the critical pressure of CO₂, this temperature and this pressure being maintained until the completion of the reaction.

Alternatively, the operation of pressurising and heating the reactor can be sequenced as follows:
an operation of pressurising and heating the reactor to a temperature greater than the critical temperature of CO₂ and to a pressure greater than the critical pressure of CO₂, the temperature and this pressure being chosen to give rise to impregnation without reacting the polymeric part with the functional compound followed by optional precipitation of the functional compound;
an operation of increasing the pressure and the temperature, the temperature and the pressure being set so as to enable the covalent reaction of the functional compound with the part, this temperature and this pressure being maintained until the completion of said reaction,

this sequence of operations optionally being repeated one or more times.

The placing operation can be performed, advantageously, in such a way that there is no direct contact between the polymeric part and the functional compound, the optional compound and the optional cosolvent.

Following the reaction step, the polymeric parts are thus chemically modified and are bonded covalently to (or grafted, covalently, by) residues of the functional compound (the residues being what remains of the functional compound after it has reacted via the isocyanate group(s) thereof with the amine groups and/or the hydroxyl groups of the polymeric part, it being understood that these residues further comprise at least one vinyl type polymerisable group from the functional compound).

After the reaction step, the supercritical conditions are conventionally removed, for example, by depressurising the reactor, wherein the reaction has taken place.

The polymeric part thus modified can then undergo drying, for example, in a vacuum, before initiating the polymerisation step.

Secondly, the process according to the invention comprises, using the vinyl type polymerisable groups of the residues of the functional compound, a step of polymerising a second compound comprising at least one vinyl type polymerisable group and at least one group comprising at least one phosphorus atom, the polymerisation thus being propagated from the residues of the functional compound, via the vinyl type polymerisable groups thereof. Following this step, a modified polymeric part bonded to grafts consisting of polymeric chains from the polymerisation of the second compound is thus obtained, the bond between the polymeric part and the grafts forming via the residues of the functional compound which form organic spacer groups between the polymeric part and the grafts, these residues being bonded, on one hand, covalently, to the modified polymeric part and, on the other, covalently, to the grafts mentioned above. In this case, the residues are what remains of the functional compound after it has reacted, on one hand, via the isocyanate group(s) thereof with the amine groups and/or the hydroxyl groups of the polymer(s) of the polymeric part and, on the other, via the vinyl type polymerisable group(s) thereof with the second compound.

This polymerisation step is carried out in the presence of at least one supercritical fluid, advantageously identical to that used during the reaction step with the functional compound, such as supercritical CO₂.

The second compound comprises at least one vinyl type polymerisable group and at least one group comprising at least one phosphorus atom, which forms the functional group of interest as it is capable of imparting flame-retardant properties to the polymeric part.

More specifically, the second compound comprises at least one vinyl type polymerisable group and, as group(s) comprising at least one phosphorus atom, at least one phosphorus group or a phosphonate group.

By way of example, the second compound can be bis[2-(methacryloyloxy)ethyl]phosphate, diethylallylphosphate, diethylallylphosphonate, dimethylvinylphosphonate or diethylvinylphosphonate.

This polymerisation step can be carried out in the presence of a cosolvent and/or a polymerisation initiator, such as a free radical initiator, for example, a nitrile compound, such as azobisisobutyronitrile (AIBN).

The polymerisation step can be a radical polymerisation reaction, this reaction optionally being induced by a free radical initiator, such as AIBN.

More specifically, the polymerisation step can include the following operations:
a step of placing, in a reactor, the polymeric part having reacted with the functional compound and the second compound;
an operation of introducing CO₂ into the reactor;
an operation of pressurising and heating the reactor to a temperature greater than the critical temperature of CO₂ and to a pressure greater than the critical pressure of CO₂, to give rise to impregnation without reacting the polymeric part with the second compound followed by optional precipitation of the second compound;
a step of introducing a polymerisation initiator into the reactor, the temperature and pressure being maintained at supercritical values.

The placing operation can be performed, advantageously, in such a way that there is no direct contact between the polymeric part and the compound(s), the optional cosolvent and the optional other ingredient(s).

Following the polymerisation step, the process comprises, advantageously, a step of stopping the supercritical conditions and optionally a step of drying the modified polymeric part.

The process according to the invention can be carried out in a device, for example, of the autoclave type, comprising an enclosure intended to receive the polymeric part, the reagents, the supercritical fluid, the optional cosolvent and the optional catalyst, means for regulating the pressure of said enclosure for the evacuation thereof (for example, via a vacuum pump communicating with the enclosure) and heating means.

Further advantages and features of the invention will emerge in the non-limiting detailed description below.

### BRIEF DESCRIPTION OF THE DRAWINGS

FIG. 1 is an infrared spectrum with a y-axis representing the absorbance (A) and an x-axis representing the wave number N (in cm⁻¹), the curve a) corresponding to the compound OP alone, the curve b) to the untreated part and curve c) to the functionalised part.

### DETAILED DESCRIPTION OF PREFERRED EMBODIMENTS

### Example 1

This example illustrates the implementation of a specific embodiment of the chemical modification process according to the invention consisting of a chemical modification of a part made of polyamide-12, so as to improve the flame-retardant properties thereof.

For this purpose, an organophosphorus compound, bis[2-(methacryloyloxy)ethyl]phosphate (hereinafter referred to as “OP”), was chosen and three phases, which will be developed in more detail hereinafter, were carried out:

a) a liquid-phase synthesis phase of an intermediate compound (hereinafter referred to as intermediate isocyanate/OP compound) by reacting hexamethyldiisocyanate with bis[2-(methacryloyloxy)ethyl]phosphate, this step being capable of being illustrated with the following reaction diagram:

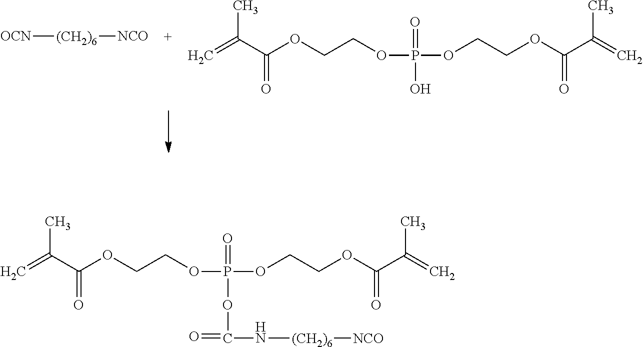

b) a step of grafting, in supercritical CO₂, the intermediate isocyanate/OP compound with polyamide-12, this step being capable of being illustrated by the following reaction diagram:

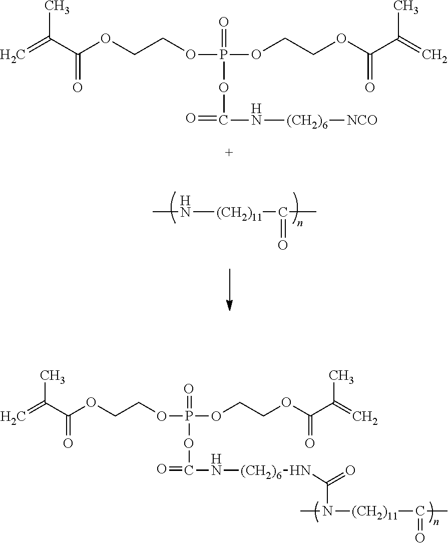

n corresponding to the repeat number of the repeat unit between brackets.

c) a phase of polymerising the organophosphorus compound OP, this step being capable of being illustrated by the following reaction diagram:

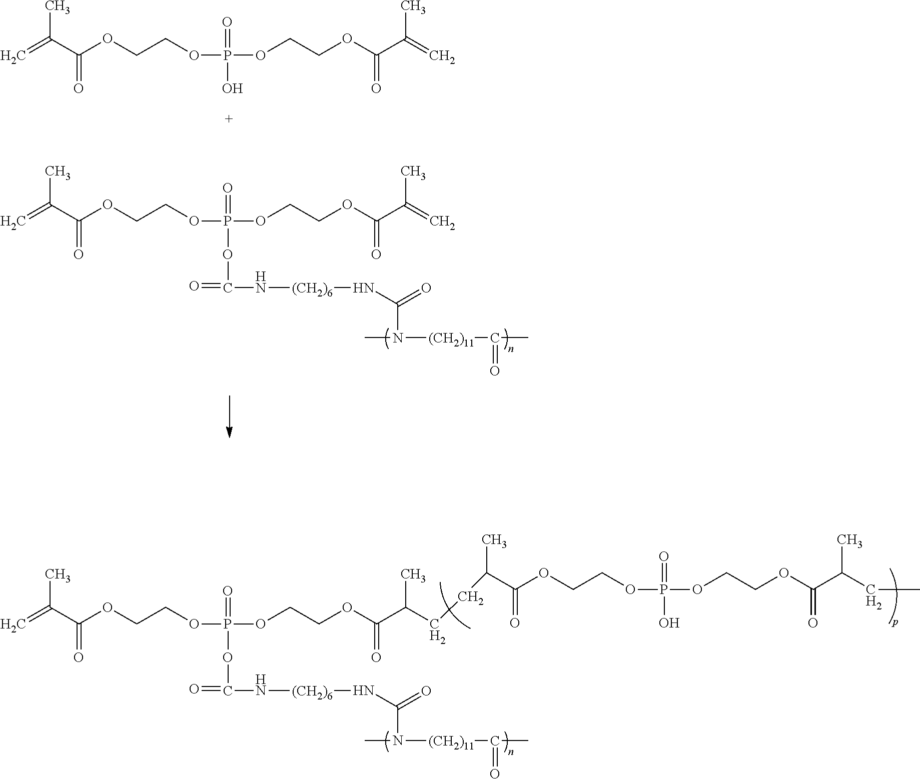

n corresponding to the repeat number of the repeat unit of the polyamide and p corresponding to the repeat number of the repeat unit between brackets.

1) Synthesis of the Intermediate Isocyanate/OP Compound

The table below illustrates, in order, the steps for accessing synthesis of the intermediate isocyanate/OP compound.

| | |
|---|---|
| Step 1 | Introduction of 1.2 g of 1,4-diazabicyclo[2.2.2]octane |
| | (DABCO) (11 mmol), as a catalyst, into a glass container |
| Step 2 | Purging of the container with argon |
| Step 3 | Addition of 10 mL of anhydrous acetone |
| Step 4 | Stirring of the mixture under argon bubbling until the |
| | DABCO has completely dissolved |
| Step 5 | Addition of 3.4 g of OP previously dissolved in 5 mL of |
| | anhydrous acetone |
| Step 6 | Stirring of the mixture under argon bubbling |
| Step 7 | Addition of 1.8 g of hexamethyldiisocyanate (11 mmol) |
| Step 8 | Stirring of the mixture under argon bubbling until the |
| | reagents have completely dissolved |
| Step 9 | Obtaining the intermediate isocyanate/OP compound |

2) Grafting of the Intermediate Compound onto a Part Made of Polyamide-12 and Polymerisation of the Organophosphorus Compound

The initial part made of polyamide-12 is a parallelepipedal test specimen having a length of 127 mm, a width of 12.7 mm, a thickness of 5 mm and a mass between 7 and 8 g.

The aforementioned part undergoes the following successive steps:
a step of impregnation/grafting of the intermediate compound (referred to as “Step 1” below);
a step of impregnation with a free radical initiator (azobisisobutyronitrile AiBN) and OP compound (referred to as “Step 2a” below);
a step of polymerising the organophosphorus compound OP (referred to as “Step 2b” below);

These three steps are conducted in supercritical CO₂ in a “batch” type reactor. More specifically, the reactor is a 600 mL “batch” type stainless steel reactor equipped with an external heating system. CO₂ is introduced into the reactor with a dual-piston pump in which the heads are cooled to a temperature less than 5° C. to obtain a liquid-phase CO₂ at this stage prior to the reaction. It is equipped, at the bottom thereof, with a 60 mL capacity crystalliser intended to receive the reagents, the optional catalyst and the optional cosolvent. The part made of polyamide-12 is suspended over the crystalliser to prevent any contact therewith. The experiments commence at ambient temperature. The reactor is then pressurised to a target pressure and then heated to the desired temperature. The part is kept under the treatment conditions for a necessary time until the completion of the reaction in question. The heating of the reactor is then switched off inducing a slow depressurisation. The residual pressure is evacuated with the various valves located on the cover of the reactor.

More specifically, the operating conditions of the steps mentioned above are listed in the table below.

| | |
|---|---|
| Step 1 | Introduction of the intermediate isocyanate/OP compound |
| | previously synthesised and the part made of polyamide-12 in |
| | the reactor and reaction in supercritical CO₂ (300 bar, 100° |
| | C.) for 4 hours |
| Step 2a | Introduction of 0.5 g of AiBN and introduction of 3 g of OP |
| | compound into the reactor in supercritical CO₂ (100 bar, 60° |
| | C.) for 1 hour enabling the impregnation and decomposition |
| | of AiBN |
| Step 2b | Increase in the pressure (300 bar) and temperature (100° C.) |
| | and holding for 2 hours for the polymerisation of OP |
| | compound |

The part obtained following these steps is homogeneous and has a black colour.

It is analysed by infrared spectroscopy in comparison to OP compound alone and a similar but untreated part.

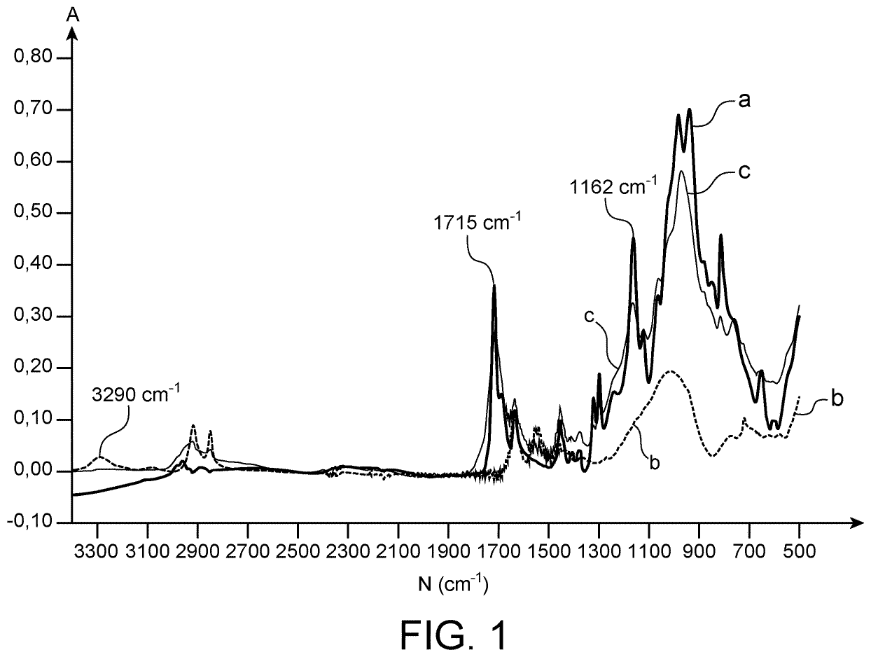

The infrared spectrum obtained is illustrated in FIG. 1, the y-axis representing the absorbance (A) and the x-axis the wave number N (in cm⁻¹), the curve a) corresponding to OP compound alone, the curve b) to the untreated part and curve c) to the functionalised part.

The peak 3290 cm⁻¹ corresponds to the N—H group and only belongs to the untreated polyamide-12. The two peaks at 1715 cm⁻¹ and 1162 cm⁻¹, for their part, are only characteristics of the commercial organophosphorus compound.

The spectrum obtained with the functionalised polyamide-12 part therefore confirms the presence of the phosphate group on the treated part and thus validates the chemical synthesis.

The evaluation of the flame-retardant behaviour of the parts (one functionalised part and one non-functionalised part) is also carried out according to the UL94V standard. For this, a flame is applied on the vertically positioned part for 10 seconds. The residual combustion and incandescence times and the flow of ignited drops from the sample are then evaluated. Two ignitions are applied for this test.

The results of the test are listed in the table below.

| | Non-functionalised | Functionalised |
|---|---|---|
| Evaluation criteria | part | part |
| Combustion time during | 5 seconds | 0 seconds |
| application of first flame | | |
| Combustion time during | 5 seconds | 2 seconds |
| application of second flame | | |
| Incandescent polyamide | Yes | No |
| flow | | |

While the untreated parts exhibit ignited drop flows on each ignition, no combustion, or incandescence, or ignited drop flow were observed for the functionalised part, which demonstrates the effectiveness of the flame-retardant property.

Furthermore, under the effect of the flammability test, the non-functionalised parts display a molten effect, whereas for the functionalised part, the formation of a crust under the effect of the flame makes it possible to prevent any ignition or ignited flows (which proves the effectiveness of the flame-retardant properties).

What is claimed is:

1.-14. (canceled)

15. Process for chemically modifying a polymeric part in order to impart flame-retardant properties thereto or to improve said properties, said process comprising the following steps:
a step of reacting a polymeric part comprising at least one polymer comprising, as reactive groups, amine groups and/or hydroxyl groups, with a functional compound, referred to as first compound, comprising at least one isocyanate group and at least one vinyl type polymerisable group, the isocyanate groups reacting, covalently with all or some of the amine groups and/or hydroxyl groups of the polymer(s), resulting in a polymeric part bonded, covalently, to residues of the functional compound;
using the vinyl type polymerisable groups of the residues of the functional compound, a step of polymerising a second compound comprising at least one vinyl type polymerisable group and at least one group comprising at least one phosphorus atom,
said reaction step and said polymerisation step being carried out in the presence of at least one supercritical fluid.

16. Process according to claim 15, wherein the supercritical fluid is supercritical CO₂.

17. Process according to claim 15, wherein the polymeric part is a part comprising one or more polyamides.

18. Process according to claim 15, wherein the polymeric part is a part made of polyamide-12.

19. Process according to claim 15, wherein the polymeric part is a part made of polyamide-12, which has a density less than or equal to 960 kg/m³, preferably less than or equal to 900 kg/m³.

20. Process according to claim 19, wherein the density is less than or equal to 960 kg/m³.

21. Process according to claim 19, wherein the density is less than or equal to 900 kg/m³.

22. Process according to claim 15, wherein the functional compound is a non-polymeric compound.

23. Process according to claim 15, wherein the functional compound is a compound comprising an isocyanate group, at least one vinyl type polymerisable group and at least one group comprising at least one phosphorus atom.

24. Process according to claim 15, wherein the functional compound complies with the following formula:

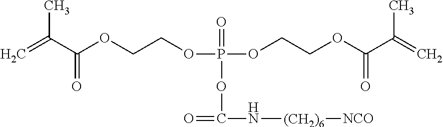

25. Process according to claim 15, wherein the step of reacting a polymetric part is carried out in the presence of at least one cosolvent and/or at least one catalyst.

26. Process according to claim 15, wherein the step of reacting the polymeric part includes the following operations:
an operation of placing, in a reactor, the polymeric part, the functional compound, optionally at least one cosolvent and optionally at least one catalyst;
an operation of introducing CO₂ into the reactor;
an operation of pressurising and heating the reactor to a temperature greater than the critical temperature of CO₂ and to a pressure greater than the critical pressure of CO₂, this temperature and this pressure being maintained until the completion of the reaction.

27. Process according to claim 15, wherein the polymerisation step is carried out in the presence of at least one supercritical fluid, identical to that used during the reaction step with the functional compound.

28. Process according to claim 15, wherein the second compound comprises, as groups(s) comprising at least one phosphorus atom, at least one phosphate group.

29. Process according to claim 15, wherein the second compound is bis[2-(methacryloyloxy)ethyl]phosphate.

30. Process according to claim 15, wherein the polymerisation step is carried out in the presence of a free radical initiator.
